(19) United States
(12) Patent Application Publication
(10) Pub. No.: US 2021/0058495 A1
(43) Pub. Date: Feb. 25, 2021

(54) COMMUNICATION DEVICE, COMMUNICATION SYSTEM, AND PROTOCOL SWITCHOVER METHOD

(71) Applicant: TOYOTA JIDOSHA KABUSHIKI KAISHA, Toyota-shi (JP)

(72) Inventor: Hirofumi YAMAKAWA, Nisshin-shi (JP)

(73) Assignee: TOYOTA JIDOSHA KABUSHIKI KAISHA, Toyota-shi (JP)

(21) Appl. No.: 16/922,044

(22) Filed: Jul. 7, 2020

(30) Foreign Application Priority Data
Aug. 21, 2019 (JP) 2019-151514

(51) Int. Cl. H04L 29/06; H04L 29/14

(52) U.S. Cl. CPC H04L 69/18; H04L 69/40; H04L 69/16

(57) ABSTRACT

A communication device including: a memory; and a processor coupled to the memory, the processor being configured to: transmit a communication frame toward another communication device connected to the communication device through a communication path; determine whether or not an error has occurred in the transmission of the communication frame; and switch a communication method for transmitting the communication frame from a first protocol to a second protocol that has a slower communication speed than the first protocol, in a case in which determination is made that an error occurrence rate during transmission using the first protocol is equal to or greater than a predetermined limit.

### CROSS-REFERENCE TO RELATED APPLICATION

This application is based on and claims priority under 35 USC 119 from Japanese Patent Application No. 2019-151514 filed on Aug. 21, 2019, the disclosure of which is incorporated by reference herein.

### BACKGROUND

### Technical Field

The present disclosure relates to a communication device, a communication system, and a protocol switchover method.

### Related Art

Japanese Patent Application Laid-Open (JP-A) No. 2017-188794 discloses a controller for communication control. This controller is capable of suppressing an increase in traffic in communications by controller area network (CAN) protocol when data frames of an ongoing standby state that arise from losing arbitration are transmitted over a communication path.

In cases in which a standby duration arising from losing arbitration has exceeded a predetermined duration, the communication control controller switches from the CAN protocol to a controller area network with flexible data rate (CAN-FD) protocol to enable a faster communication speed, and performs transmission.

During communication by CAN-FD protocol, which has a shorter communication duration per bit than communication by CAN protocol, there is less slack available when the convergence time for the communication waveform, for example rises and falls in the waveform, and ringing etc., is considered than in CAN protocol. Thus, switching from CAN protocol to CAN-FD protocol leads to a greater likelihood of incorrect sampling and a greater likelihood of communication abnormalities occurring, and to a reduction in communication quality.

### SUMMARY

An object of the present disclosure is to provide a communication device, a communication system, and a protocol switchover method capable of both high speed and robust communication by primarily performing communication using a protocol with a high communication speed, but switching to a protocol with a lower communication speed in cases in which a communication error has occurred when using the high speed protocol.

A first aspect is a communication device including a transmission section configured to transmit a communication frame toward another communication device connected to the communication device through a communication path, a determination section configured to determine whether or not an error has occurred in the transmission of the communication frame by the transmission section, and a switchover section configured to switch a communication method of the transmission section from a first protocol to a second protocol that has a slower communication speed than the first protocol, in a case in which determination is made that an error occurrence rate during transmission using the first protocol is equal to or greater than a predetermined limit.

The communication device of the first aspect is connected to the other communication device through the communication path. The transmission section of the communication device transmits the communication frame toward the other communication device, and the determination section determines whether or not an error has occurred in the transmission of the communication frame. The switchover section of the communication device switches the communication method from the first protocol to the second protocol in a case in which determination is made that the error occurrence rate during transmission using the first protocol is equal to or greater than the predetermined limit. Note that the second protocol has a slower communication speed than the first protocol. Accordingly, the communication device enables both high speed and robust communication by primarily performing communication using the first protocol, but switching to the second protocol in a case in which communication errors arise in the first protocol.

A communication device of a second aspect is the communication device of the first aspect, wherein the transmission section is configured to direct a notification toward the other communication device to request a switch to the second protocol in a case in which the communication method is to be switched from the first protocol to the second protocol, and the switchover section is configured to switch the communication method of the transmission section from the first protocol to the second protocol, in a case in which a predetermined duration has elapsed without receiving a response advising of a switch to the second protocol from the other communication device toward which the notification was directed.

The communication device of the second aspect directs a notification toward the other communication device to request a switch to the second protocol in a case in which the communication method is to be switched from the first protocol to the second protocol. The switchover section switches the communication method from the first protocol to the second protocol in a case in which the predetermined duration has elapsed without receiving a response advising of a switch to the second protocol from the other communication device toward which the notification was directed. This communication device enables switching to be performed even in cases in which there is an issue with communication with the other communication device during protocol switching.

A communication device of a third aspect is the communication device of the first aspect or the second aspect, wherein the switchover section is configured to switch the communication method of the transmission section from the second protocol to the first protocol, in a case in which determination is made that an error occurrence rate during transmission using the second protocol is less than a predetermined limit.

In the communication device of the third aspect, the switchover section switches the communication method from the second protocol to the first protocol in a case in which determination is made that the error occurrence rate is less than the predetermined limit. In this communication device, switching the communication method to the first protocol, which has a higher communication speed than communication by the second protocol, in a case in which the communication situation between the communication device and the other communication device has improved enables a communication lag to be suppressed.

A communication device of a fourth aspect is the communication device of any one of the first aspect to the third aspect, wherein the transmission section is controlled based on a CAN protocol and a CAN-FD protocol, the communication device further includes a conversion section that is configured to perform conversion to divide communication data included in a communication frame based on the CAN-FD protocol serving as the first protocol, and allocate the divided communication data to communication frames based on the CAN protocol serving as the second protocol, and the conversion section is configured to allocate the divided communication data to the communication frames based on the CAN protocol in sequence from a shortest permitted lag time.

In the communication device of the fourth aspect, when switching the communication method from the CAN-FD protocol to the CAN protocol, the conversion section divides the communication data included in the communication frame based on the CAN-FD protocol and allocates the divided communication data to communication frames based on the CAN protocol in sequence from the shortest permitted lag time. Communication data with a higher priority such as that relating to equipment control is sometimes set with a shorter permitted lag time for communication. The communication device thus enables a lag to be suppressed when transmitting high priority communication data, even in a state in which the communication speed has slowed.

A communication device of a fifth aspect is the communication device of any one of the first aspect to the fourth aspect, further including an error counter to count errors based on a CAN protocol and a CAN-FD protocol, configured to increment a number of errors in a case in which an error is determined to have occurred, and to decrement the number of errors in a case in which transmission is determined to have been successful. When a count value in the error counter is taken as the error occurrence rate, a count value set as the predetermined limit is a lower value than a count value at which a transmission state of the transmission section is switched from an active state to a passive state.

The communication device of the fifth aspect employs the error counter to count errors based on the CAN protocol and the CAN-FD protocol as a trigger for protocol switching. Note that when the error counter exceeds a predetermined count value, the transmission state transitions from an active state to a passive state and transmission is put on standby. Accordingly, in this communication device, the count value employed as the predetermined limit at which protocol switchover is triggered is set to a lower value than the count value at which the transmission state switches from the active state to the passive state. In this communication device, the communication method is switched to the low speed CAN protocol prior to transmission being put on standby due to errors occurring in communication based on the CAN-FD protocol, thereby enabling a lag in communication frames to be suppressed.

A sixth aspect is a protocol switchover method including a transmission step of transmitting a communication frame from a communication device toward another communication device connected to the communication device through a communication path, a determination step of determining whether or not an error has occurred in the transmission of the communication frame during the transmission step, and a switchover step of switching a communication method from a first protocol to a second protocol that has a slower communication speed than the first protocol, in a case in which determination is made that an error occurrence rate during transmission using the first protocol is equal to or greater than a predetermined limit.

The protocol switchover method of the sixth aspect is applied to the communication device and the other communication device connected to the communication device through a communication path. In this protocol switchover method, when the transmission step has been executed to transmit a communication frame from the communication device toward the other communication device, at the determination step determination is made as to whether or not an error has occurred in the transmission. In a case in which the error occurrence rate during transmission using the first protocol is determined to be equal to or greater than the predetermined limit, at the switchover step the communication method is switched from the first protocol to the second protocol. As described above, the second protocol has a slower communication speed than the first protocol. Accordingly, this protocol switchover method enables both high speed and robust communication by primarily performing communication using the first protocol, but switching to the second protocol in a case in which communication errors arise in the first protocol.

The present disclosure enables both high speed and robust communication by primarily performing communication using a protocol with a high communication speed, but switching to a protocol with a lower communication speed in cases in which communication errors arise in the high speed protocol.

### BRIEF DESCRIPTION OF THE DRAWINGS

An exemplary embodiment of the present disclosure will be described in detail based on the following figures, wherein:

FIG. 1 is a diagram illustrating a schematic configuration of a communication system according to an exemplary embodiment;

FIG. 2 is an example of a standard format data frame structure of a CAN protocol;

FIG. 3 is an example of a standard format data frame structure of a CAN-FD protocol;

FIG. 4 is a block diagram illustrating hardware configuration of an ECU of an exemplary embodiment;

FIG. 5 is a block diagram illustrating an example of functional configuration of an ECU of an exemplary embodiment;

FIG. 6 is a flowchart illustrating a flow of transmission-side switchover processing executed by a transmission-side ECU in an exemplary embodiment;

FIG. 7 is a flowchart (continuing on from FIG. 6) illustrating a flow of transmission-side switchover processing executed by a transmission-side ECU in an exemplary embodiment;

FIG. 8 is a diagram illustrating an example of a communication frame based on the CAN-FD protocol in an exemplary embodiment;

FIG. 9 is a diagram illustrating an example of communication frames based on the CAN protocol in an exemplary embodiment;

FIG. 10 is a flowchart illustrating a flow of reception-side switchover processing executed by a reception-side ECU in an exemplary embodiment; and

FIG. 11 is a flowchart (continuing on from FIG. 10) illustrating a flow of reception-side switchover processing executed by a reception-side ECU in an exemplary embodiment.

### DETAILED DESCRIPTION

Communication System

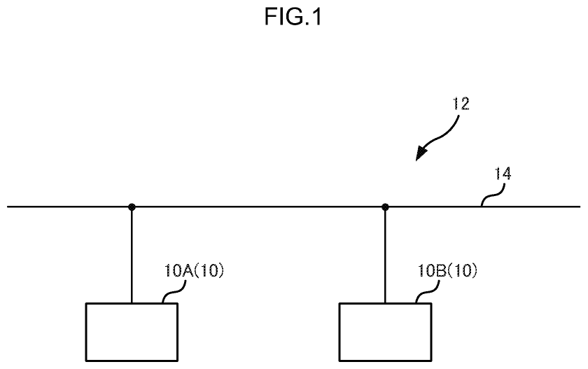

FIG. 1 is a block diagram illustrating a schematic configuration of a communication system 12 according to an exemplary embodiment. As illustrated in FIG. 1, the communication system 12 according to the present exemplary embodiment is configured including plural electronic control units (ECUs) 10 configuring nodes, and a bus 14 configuring a communication path that connects the plural ECUs 10. The communication system 12 of the present exemplary embodiment is for example formed as a network that connects various ECUs 10 provided to a vehicle.

FIG. 1 illustrates two ECUs 10, namely an ECU 10A and an ECU 10B. The ECU 10A is an example of a communication device, and the ECU 10B is an example of another communication device. In the following explanation, the ECU 10A configures a transmission-side node that transmits communication frames, and the ECU 10B configures a reception-side node that receives communication frames. Note that further ECUs 10 may also be connected to the bus 14 in addition to the ECU 10A and the ECU 10B. Although a bus-type bus structure is adopted for the communication system 12 of the present exemplary embodiment, there is no limitation thereto, and a star-type, a ring-type, or a line-type (daisy chain connection) bus structure may be adopted.

In the communication system 12 of the present exemplary embodiment, a controller area network (CAN) protocol and a controller area network with flexible data rate (CAN-FD) protocol that allows a faster communication speed than the CAN protocol are adopted as communication methods for communication between the ECUs 10. Note that the CAN-FD protocol is an example of a first protocol, and the CAN protocol is an example of a second protocol.

Communication Methods

Explanation follows regarding the CAN protocol and the CAN-FD protocol, these being the communication methods applied in the communication system 12 of the present exemplary embodiment. In the present exemplary embodiment, a communication frame refers to a data frame conforming to the corresponding protocol.

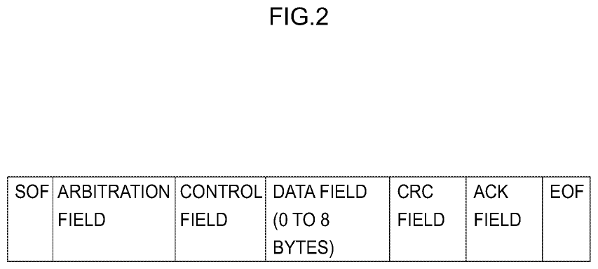

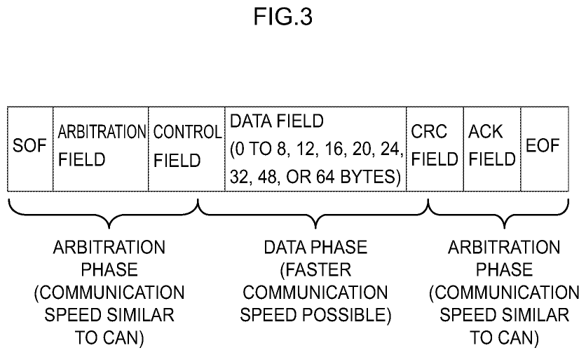

FIG. 2 illustrates an example of a standard format data frame structure of the CAN protocol, and FIG. 3 illustrates an example of a standard format data frame structure of the CAN-FD protocol. In each protocol, the data frame is configured including a start of frame (SOF), an arbitration field, a control field, a data field, a cyclic redundancy check (CRC), an acknowledgement (ACK) field, and an end of frame (EOF).

The SOF is a 1 bit frame field with a function of indicating the start of the data frame.

The arbitration field is a frame field including an 11 bit ID employed to identify the data content.

The control field is a frame field including a 4 bit DLC (data length code) employed to define the data length.

The data field is a section including the data for transmission, and configures a communication data carrying field of the present exemplary embodiment. In the CAN protocol, the data length can be set within a range from 0 byes to 8 bytes (see FIG. 2). In the CAN-FD protocol, the data length can be set within a range from 0 bytes to 8 bytes, or to 12, 16, 20, 24, 32, 48, or 64 bytes (see FIG. 3).

The CRC field is a frame field including a CRC sequence that is a computation result computed based on ID, control field, data field, and other transmission values.

The ACK field is a frame field including a 1 bit ACK slot employed in receipt confirmation.

The EOF is a 1 bit frame with a function of indicating the end of the data frame.

As illustrated in FIG. 3, a data phase including the data field in the data frame of the CAN-FD protocol enables higher speed forwarding than the data frame of the CAN protocol.

Note that arbitration phases provided before and after the data phase have similar communication speeds to those of the CAN protocol.

ECU

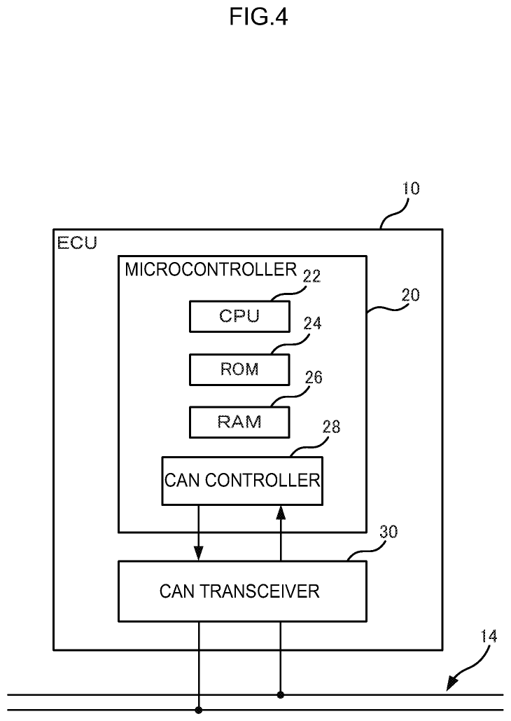

As illustrated in FIG. 4, each of the ECUs 10 of the present exemplary embodiment is configured including a microcontroller 20 and a CAN transceiver 30. The microcontroller 20 is configured including a central processing unit (CPU) 22, read only memory (ROM) 24, random access memory (RAM) 26, and a CAN controller 28. The CPU 22 is an example of a processor, and the RAM 26 is an example of memory.

The CPU 22 is a central processing unit that executes various programs and controls various sections. Namely, the CPU 22 reads a program from the ROM 24 and executes the program using the RAM 26 as a workspace. In the present exemplary embodiment, an execution program is stored in the ROM 24.

The ROM 24 stores various programs and various data. The RAM 26 serves as a workspace to temporarily store a program or data.

The CAN controller 28 is configured to implement functionality relating to the CAN protocol or the CAN-FD protocol, such as communication arbitration and error checking functionality.

The CAN transceiver 30 is connected to the microcontroller 20 and the bus 14, and includes functionality to transmit communication frames input by the microcontroller 20 through the bus 14, and input communication frames forwarded through the bus 14 to the microcontroller 20.

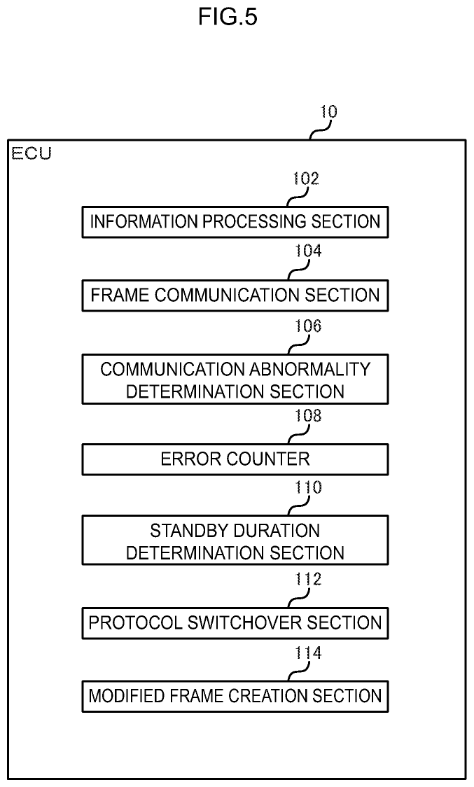

FIG. 5 is a block diagram illustrating an example of functional configuration of the respective ECUs 10. As illustrated in FIG. 5, each of the ECUs 10 includes an information processing section 102, a frame communication section 104, a communication abnormality determination section 106, an error counter 108, a standby duration determination section 110, a protocol switchover section 112, and a modified frame creation section 114. Each of these functional configurations is implemented by the CPU 22 reading and executing the execution program stored in the ROM 24.

The information processing section 102 includes functionality to process information acquired from other ECUs 10 and sensors in various locations. For example, in cases in which the ECU 10 is an engine ECU that controls the vehicle engine, the information processing section 102 acquires information from the sensors at various locations in the engine, and outputs signals to drive actuators of a throttle and the like.

The frame communication section 104 serves as a transmission section and a receiving section, and includes functionality to perform communication of information frames with other ECUs 10. Each information frame includes communication data relating to information acquired or output by the information processing section 102. The frame communication section 104 of the present exemplary embodiment is controlled based on the CAN protocol and the CAN-FD protocol communication methods. Thus, each information frame has a format conforming to either the CAN protocol or the CAN-FD protocol.

The communication abnormality determination section 106 serves as a determination section, and includes functionality to determine whether or not an error has occurred during communication of an information frame. Note that five types of error are defined in the CAN protocol and the CAN-FD protocol, these being bit errors, form errors, ACK errors, CRC errors, and stuffing errors. A bit error is detected when the transmission level of the transmission-side ECU 10 and the level of the bus 14 are different. A form error is detected when there is an error in the bits having a fixed bit level. An ACK error is detected when an ACK is not sent from the reception-side ECU 10. A CRC error is detected when the CRC sequence included in a communication frame received by the reception-side ECU 10 is different from the CRC computed based on the data in the communication frame. A stuffing error is detected when a bit stuffing rule has been broken. Note that these error mechanisms are described in detail in JP-A No. 2019-087890.

In the ECU 10A configuring the node on the transmission side, the communication abnormality determination section 106 determines that a transmission error has occurred in cases in which transmission of the information frame has failed. Specifically, the communication abnormality determination section 106 of the ECU 10A determines that a transmission error has occurred in cases in which a bit error, a form error, or an ACK error has been detected.

In the ECU 10B configuring the node on the reception side, the communication abnormality determination section 106 determines that a reception error has occurred in cases in which receipt of the information frame has failed. Specifically, the communication abnormality determination section 106 of the ECU 10B determines that a reception error has occurred in cases in which a CRC error, a form error, or a stuffing error has been detected. In cases in which the communication abnormality determination section 106 of the ECU 10B determines that a reception error has occurred, an error frame is transmitted from the ECU 10B toward the ECU 10A. On receiving the error frame from the ECU 10B, the communication abnormality determination section 106 of the ECU 10A determines that a transmission error has occurred in the ECU 10A.

The error counter 108 includes functionality to count the number of times an error has been determined by the communication abnormality determination section 106. The error counter 108 includes a transmission error counter and a reception error counter. The transmission error counter increments the transmission error count in cases in which a transmission error is determined to have occurred, and decrements the transmission error count in cases in which transmission is determined to have been successful. The reception error counter increments the reception error count in cases in which a reception error is determined to have occurred, and decrements the reception error count in cases in which reception is determined to have been successful.

The error counter 108 of the present exemplary embodiment is a counter based on the CAN protocol and the CAN-FD protocol, and has a count value between 0 and 255. In the transmission-side ECU 10A, the ECU 10A remains in an active state and is able to perform transmission in cases in which the count value is between 0 and 127, whereas the ECU 10A is placed in a passive state and transmission is put on standby in cases in which the count value is between 128 and 255. When in the passive state, an interval between data frames becomes 8 bits longer. This results in a poorer communication lag time for communication frames in the bus 14. Note that when the count value reaches 255, the ECU 10A is placed in a bus-off state and is disconnected from the bus 14.

The standby duration determination section 110 includes functionality to measure a standby duration when a protocol switchover request requesting to switch protocols has been transmitted to the ECU 10B. In cases in which a predetermined duration configuring the standby duration has elapsed without receiving protocol switchover permission, this being notification permitting protocol switchover, from the ECU 10B to which the protocol switchover request was transmitted, the protocol switchover section 112, described below, switches the protocol.

The protocol switchover section 112 serves as a switchover section, and includes functionality to switch the protocol applied in by frame communication section 104. In cases in which determination is made that the transmission error occurrence rate in the ECU 10A equal to or greater than a predetermined limit when using the CAN-FD protocol, the protocol switchover section 112 is able to switch the communication method from the CAN-FD protocol to the CAN protocol. Moreover, in cases in which determination is made that that the transmission error occurrence rate is less than the predetermined limit when using the CAN protocol, the protocol switchover section 112 is able to switch the communication method from the CAN protocol to the CAN-FD protocol. The protocol switchover section 112 switches the protocol either when the protocol switchover permission has been received from the ECU 10B, or when the predetermined duration has elapsed.

In the ECU 10B, the protocol switchover section 112 switches the protocol either when the protocol switchover request has been received from the ECU 10A, or when a predetermined duration has elapsed.

Note that the “error occurrence rate” is defined in terms of the count value of the error counter 108. The predetermined limit at which protocol switchover is triggered is set to a lower value than the count value (128) at which the transmission state transitions from the active state to the passive state. For example, the predetermined limit is set to a lower value than a count value of 97 at which a warning limit is activated while still in the active state.

The modified frame creation section 114 serves as a conversion section, and includes functionality to divide communication data included in a communication frame based on the CAN-FD protocol and allocate this communication data to communication frames based on the CAN protocol. In the present exemplary embodiment, the data length of communication data in a CAN-FD protocol communication frame is set to 32 bytes. Thus, when transmitting this communication data using the CAN protocol, four communication frames including communication data with a maximum data length of 8 bytes need to be created. The modified frame creation section 114 of the present exemplary embodiment allocates the divided communication data from the CAN-FD protocol to communication frames based on the CAN protocol in sequence from the shortest permitted lag time.

### Operation

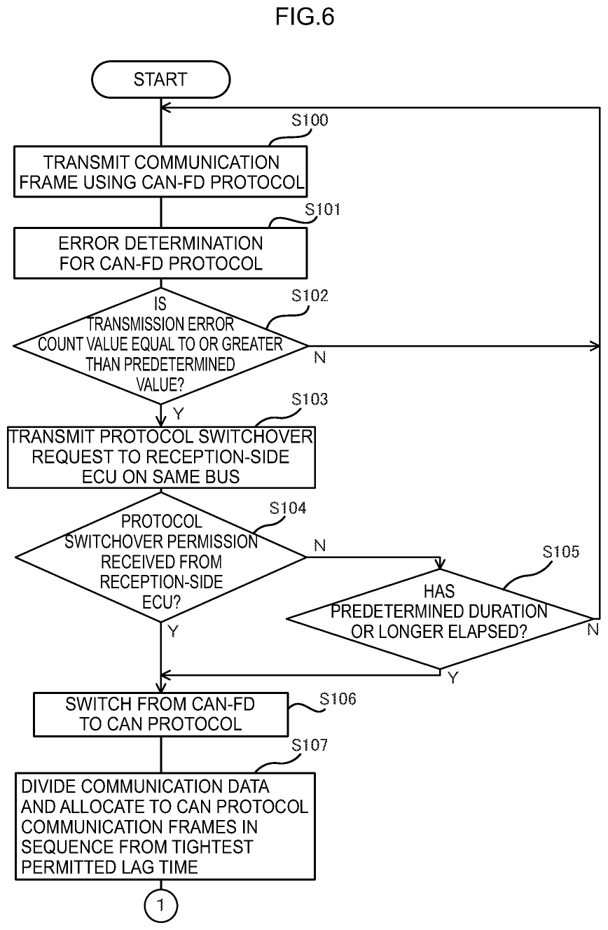

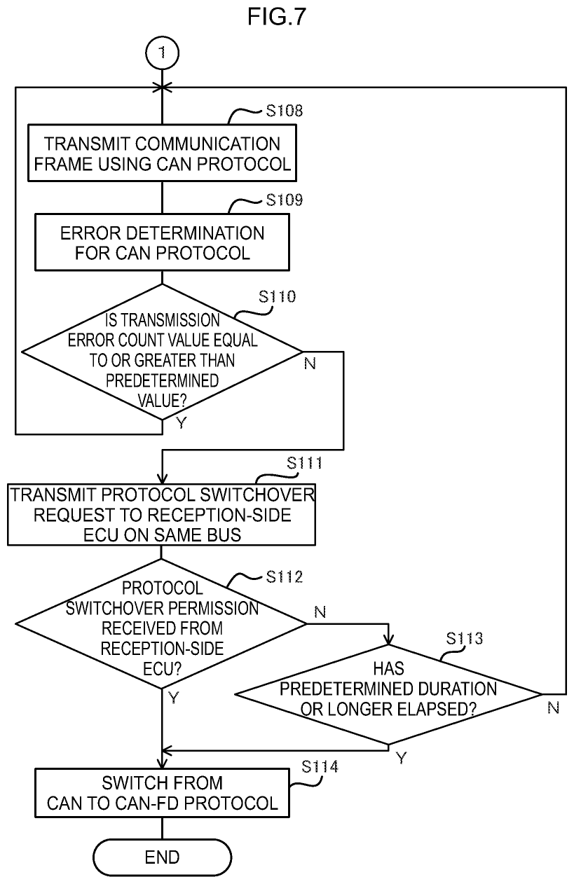

Next, explanation follows regarding a flow of transmission-side switchover processing executed by the ECU 10A on the transmission side when transmitting communication frames from the ECU 10A toward the ECU 10B in the present exemplary embodiment, with reference to the flowcharts in FIG. 6 and FIG. 7.

In the communication system 12 of the present exemplary embodiment, in principle communication using the CAN-FD protocol is prioritized over communication using the CAN protocol in order to speed up communication through the bus 14.

At step S100 in FIG. 6, the ECU 10A transmits a communication frame based on the CAN-FD protocol toward the ECU 10B.

At step S101, the ECU 10A executes error determination with respect to the CAN-FD protocol-based communication. A transmission error is determined to have occurred in cases in which an error has been detected in the communication frame transmitted by the ECU 10A. The ECU 10B also performs transmission error detection with respect to the received communication frame. The ECU 10A determines that a transmission error has occurred in cases in which the ECU 10B transmits an error frame to the ECU 10A. The ECU 10A increments the count value of the error counter 108 for CAN-FD protocol transmission in cases in which a transmission error has been determined, and decrements the count value in cases in which a transmission error has not been determined.

At step S102, the ECU 10A determines whether or not the transmission error count value in the error counter 108 is equal to or greater than a predetermined value set as the predetermined limit. Processing proceeds to step S103 in cases in which the ECU 10A determines that the count value is equal to or greater than the predetermined value.

Processing returns to step S100 in cases in which the ECU 10A determines that the count value is not equal to or greater than the predetermined value, namely that the count value is less than the predetermined value. Namely, the ECU 10A continues to transmit communication frames until the transmission error count value reaches the predetermined value.

At step S103, the ECU 10A transmits a protocol switchover request to the reception-side ECU 10B that is connected to the same bus 14.

At step S104, the ECU 10A determines whether or not protocol switchover permission has been received from the reception-side ECU 10B. Processing proceeds to step S106 in cases in which the ECU 10A determines that protocol switchover permission has been received. Processing proceeds to step S105 in cases in which the ECU 10A determines that protocol switchover permission has not been received.

At step S105, the ECU 10A determines whether or not a predetermined duration or longer has elapsed since the protocol switchover request was transmitted to the ECU 10B. Processing proceeds to step S106 in cases in which the ECU 10A determines the predetermined duration or longer has elapsed. Processing returns to step S100 in cases in which the ECU 10A determines that the predetermined duration or longer has not elapsed, namely determines that the elapsed duration is less than the predetermined duration. Namely, the ECU 10A continues to transmit communication frames until the predetermined duration has elapsed.

Note that measurement of the duration at step S105 is performed by the standby duration determination section 110 previously described. The predetermined duration at which protocol switchover is triggered is set to a duration that does not allow the error counter 108 to reach the count value for transitioning to the passive state. This is since allowing transmission resulting in transmission errors to be repeated for a longer predetermined duration would result in the count value increasing and a transition to the passive state.

At step S106, the ECU 10A switches the communication method from the CAN-FD protocol to the CAN protocol. As will be described below, the communication method is switched from the CAN-FD protocol to the CAN protocol in the ECU 10B accompanying transmission of the protocol switchover permission. This enables the ECU 10A to communicate with the ECU 10B using the CAN protocol.

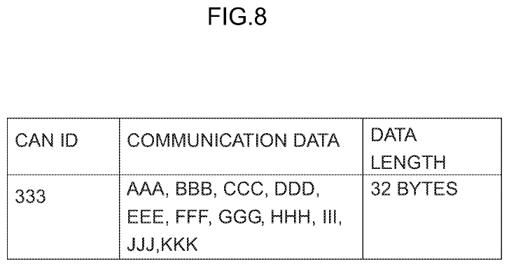

At step S107, the ECU 10A divides the communication data included in a communication frame, and allocates the communication data to CAN protocol communication frames in sequence from the tightest permitted lag time. As illustrated in FIG. 8, an example may be envisaged in which communication data with a data length of 32 bytes is included in a CAN-FD protocol communication frame. In such a case, the 32 byte communication data cannot be included in a single CAN protocol communication frame, which has a maximum data length of 8 bytes, and so the communication data needs to be divided into at least four communication frames.

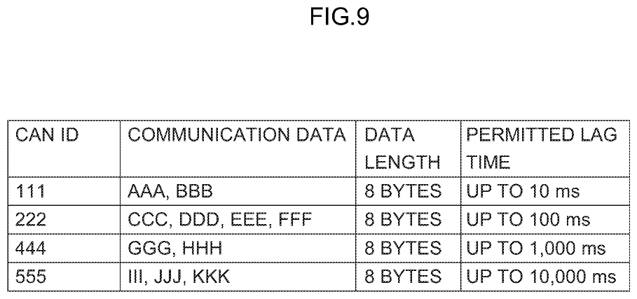

Note that at step S107, as illustrated in FIG. 9 the ECU 10A divides the communication data into 8 byte pieces, and confers a CAN ID to each of the divided communication data pieces such that the tighter the permitted lag time, the lower the CAN ID number.

For example, an ID 111 is conferred on the communication data “AAA, BBB” that has the shortest permitted lag time of up to 10 ms, and an ID 222 is conferred on the communication data “CCC, DDD, EEE, FFF” that has a permitted lag time of up to 100 ms. An ID 444 is conferred on the communication data “GGG, HHH” that has a permitted lag time of up to 1,000 ms, and an ID 555 is conferred on the communication data “III, JJJ, KKK” that has the longest permitted lag time of up to 10,000 ms. Note that the ID 333 is not used in order to avoid duplication of the ID used for the CAN-FD protocol communication frame.

At step S108 in FIG. 7, the ECU 10A transmits a communication frame based on the CAN protocol toward the ECU 10B.

At step S109, the ECU 10A executes error determination with respect to the CAN protocol-based communication. The determination method is similar to that of step S101. The ECU 10A increments the count value of the error counter 108 for CAN protocol transmission in cases in which a transmission error has been determined, and decrements the count value in cases in which a transmission error has not been determined.

At step S110, the ECU 10A determines whether or not the transmission error count value in the error counter 108 is equal to or greater than a predetermined value set as a predetermined limit. Processing returns to step S108 in cases in which the ECU 10A determines that the count value is equal to or greater than the predetermined value.

Processing proceeds to step S111 in cases in which the ECU 10A determines that the count value is not equal to or greater than the predetermined value, namely that the count value is less than the predetermined value.

At step S111, the ECU 10A transmits a protocol switchover request to the reception-side ECU 10B that is connected to the same bus 14.

At step S112, the ECU 10A determines whether or not protocol switchover permission has been received from the reception-side ECU 10B. This processing is similar to that of step S104. Processing proceeds to step S114 in cases in which the ECU 10A determines that protocol switchover permission has been received. Processing proceeds to step S113 in cases in which the ECU 10A determines that protocol switchover permission has not been received.

At step S113, the ECU 10A determines whether or not a predetermined duration or longer has elapsed since the protocol switchover request was transmitted to the ECU 10B. This processing is similar to that of step S105. Processing proceeds to step S114 in cases in which the ECU 10A determines the predetermined duration or longer has elapsed. Processing returns to step S108 in cases in which the ECU 10A determines that the predetermined duration or longer has not elapsed, namely, determines that the elapsed duration is less than the predetermined duration. Namely, the ECU 10A continues to transmit communication frames until the predetermined duration has elapsed.

At step S114, the ECU 10A switches the communication method from the CAN protocol to the CAN-FD protocol. The communication method is switched from the CAN protocol to the CAN-FD protocol in the ECU 10B accompanying transmission of the protocol switchover permission. This enables the ECU 10A to communicate with the ECU 10B using the CAN-FD protocol.

The transmission-side switchover processing is ended after going through the above processing.

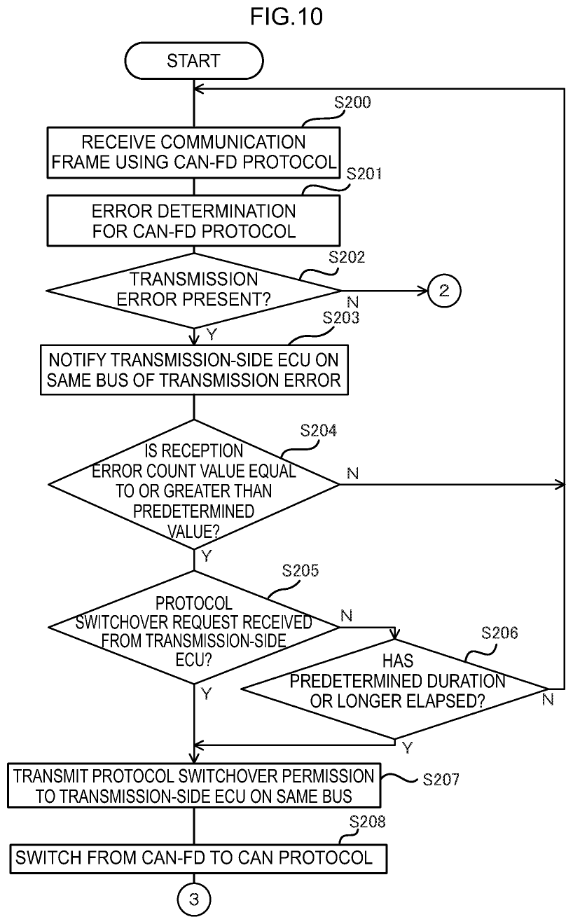

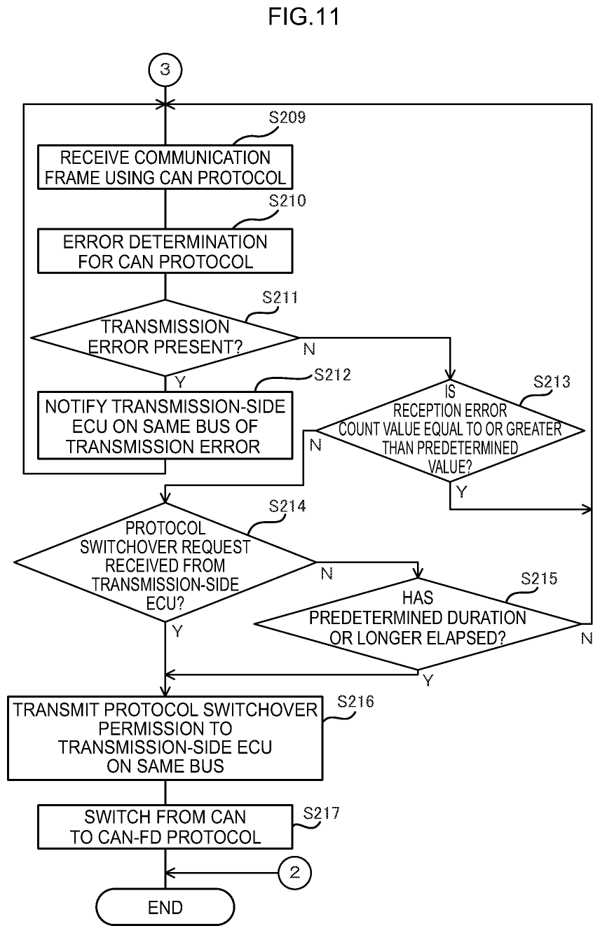

Next, explanation follows regarding a flow of reception-side switchover processing executed by the reception-side ECU 10B, with reference to the flowcharts in FIG. 10 and FIG. 11.

At step S200 in FIG. 10, the ECU 10B receives a communication frame based on the CAN-FD protocol from the ECU 10A.

At step S201, the ECU 10B executes error determination with respect to the CAN-FD protocol-based communication. A transmission error is determined to have occurred in cases in which an error is detected in the communication frame received by the ECU 10B.

At step S202, the ECU 10B determines whether or not a transmission error is present. Processing proceeds to step S203 in cases in which the ECU 10B determines that a transmission error is present. The reception-side switchover processing is ended in cases in which the ECU 10B determines that a transmission error is not present.

At step S203, the ECU 10B notifies the transmission-side ECU 10A connected to the same bus 14 of the transmission error. Specifically, the ECU 10B transmits an error frame.

At step S204, the ECU 10B determines whether or not the reception error count value in the error counter 108 is equal to or greater than a predetermined value set as a predetermined limit. Processing proceeds to step S205 in cases in which the ECU 10B determines that the count value is equal to or greater than the predetermined value. Processing returns to step S200 in cases in which the ECU 10B determines that the count value is not equal to or greater than the predetermined value, namely that the count value is less than the predetermined value. Namely, the ECU 10B continues to receive communication frames until the reception error count value reaches the predetermined value.

At step S205, the ECU 10B determines whether or not a protocol switchover request has been received from the transmission-side ECU 10A. Processing proceeds to step S207 in cases in which the ECU 10B determines that the protocol switchover request has been received. Processing proceeds to step S206 in cases in which the ECU 10B determines that the protocol switchover request has not been received.

At step S206, the ECU 10B determines whether or not a predetermined duration or longer has elapsed since the ECU 10A was notified of the transmission error. Processing proceeds to step S207 in cases in which the ECU 10B determines the predetermined duration or longer has elapsed. Processing returns to step S200 in cases in which the ECU 10B determines that the predetermined duration or longer has not elapsed, namely, determines that the elapsed duration is less than the predetermined duration. Namely, the ECU 10B continues to receive communication frames until the predetermined duration has elapsed.

At step S207, the ECU 10B transmits protocol switchover permission to the transmission-side ECU 10A connected to the same bus 14.

At step S208, the ECU 10B switches the communication method from the CAN-FD protocol to the CAN protocol. As previously described, the communication method is switched from the CAN-FD protocol to the CAN protocol in the ECU 10A in response to receipt of the protocol switchover permission. This enables the ECU 10B to communicate with the ECU 10A using the CAN protocol.

Note that the ECU 10B might be unable to receive the protocol switchover request from the ECU 10A, or be unable to transmit the protocol switchover permission to the ECU 10A when a communication error has occurred. In such cases, since the ECU 10B is set so as to switch the communication method from the CAN-FD protocol to the CAN protocol in cases in which transmission errors have persisted for a predetermined duration (see step S206), thereby enabling communication with the ECU 10A using the CAN protocol.

At step S209 in FIG. 11, the ECU 10B receives a communication frame based on the CAN protocol from the ECU 10A.

At step S210, the ECU 10B executes error determination with respect to the CAN protocol-based communication.

At step S211, the ECU 10B determines whether or not a transmission error is present. Processing proceeds to step S212 in cases in which the ECU 10B determines a transmission error is present. Processing proceeds to step S213 in cases in which the ECU 10B determines a transmission error is not present.

At step S212, the ECU 10B notifies the transmission-side ECU 10A connected to the same bus 14 of the transmission error. Specifically, the ECU 10B transmits an error frame. The processing then returns to step S209.

At step S213, the ECU 10B determines whether or not the reception error count value in the error counter 108 is equal to or greater than a predetermined value set as a predetermined limit. Processing returns to step S209 in cases in which the ECU 10B determines that the count value is equal to or greater than the predetermined value. Namely, the ECU 10B continues to receive communication frames until the reception error count value falls below the predetermined value. Processing proceeds to step S214 in cases in which the ECU 10B determines that the count value is not equal to or greater than the predetermined value, namely that the count value is less than the predetermined value.

At step S214, the ECU 10B determines whether or not a protocol switchover request has been received from the transmission-side ECU 10A. Processing proceeds to step S216 in cases in which the ECU 10B determines that the protocol switchover request has been received. Processing proceeds to step S215 in cases in which the ECU 10B determines that the protocol switchover request has not been received.

At step S215, the ECU 10B determines whether or not a predetermined duration or longer has elapsed since the ECU 10A was notified of the transmission error. Processing proceeds to step S216 in cases in which the ECU 10B determines the predetermined duration or longer has elapsed. Processing returns to step S209 in cases in which the ECU 10B determines that the predetermined duration or longer has not elapsed, namely, determines that the elapsed duration is less than the predetermined duration. Namely, the ECU 10B continues to receive communication frames until the predetermined duration has elapsed.

At step S216, the ECU 10B transmits protocol switchover permission to the transmission-side ECU 10A connected to the same bus 14.

At step S217, the ECU 10B switches the communication method from the CAN protocol to the CAN-FD protocol. The communication method is switched from the CAN protocol to the CAN-FD protocol in the ECU 10A in response to receipt of the protocol switchover permission. This enables the ECU 10B to communicate with the ECU 10A using the CAN-FD protocol.

The reception-side switchover processing is ended after going through the above processing.

### SUMMARY

In the communication system 12 of the present exemplary embodiment, the ECU 10A and the ECU 10B are connected through the bus 14 configuring a communication path. Note that in the communication system 12, in principle communication using the CAN-FD protocol is prioritized over communication using the CAN protocol in order to speed up communication through the bus 14.

The ECU 10A configuring the node on the transmission side performs error determination with respect to a transmitted communication frame, increments the count value of the error counter 108 if an error is present, and decrements the count value of the error counter 108 if an error is not present. The ECU 10B configuring the node on the reception side performs error determination with respect to a received communication frame, and notifies the ECU 10A if an error is present. The ECU 10A increments the count value of the error counter 108 on receiving the error notification.

In cases in which the ECU 10A then determines that the count value of the error counter 108 is equal to or greater than the predetermined value, the protocol switchover section 112 switches the communication method from the CAN-FD protocol to the CAN protocol that has a slower speed than the CAN-FD protocol. The ECU 10A is able to transmit a communication frame, for which a transmission error has been determined when using the CAN-FD protocol, using the CAN protocol that offers more stable communication than the CAN-FD protocol. The present exemplary embodiment thereby enables both high speed and robust communication by primarily performing high speed communication using the CAN-FD protocol, but switching to the lower speed CAN protocol in cases in which cumulative transmission errors have reached a predefined level.

In the ECU 10A of the present exemplary embodiment, the protocol switchover section 112 switches the communication method from the CAN protocol to the CAN-FD protocol in cases in which determination is made that the count value of the error counter 108 is less than the predetermined value. Namely, in the present exemplary embodiment, switching the communication method to the high speed CAN-FD protocol in cases in which the communication situation between the ECU 10A and the ECU 10B has improved enables a communication lag arising as a result of continuing to communicate using the CAN protocol to be suppressed.

Note that the error counter 108 value applied as the predetermined value at which protocol switchover is triggered should be set as a lower value (for example 96 or lower) than the count value 128 at which the transmission state transitions from the active state to the passive state. When the transmission state is placed in the passive state, transmission of communication frames is put on standby and a lag arises. Thus, were the predetermined value to be set close to the count value at which the transmission states transition there is a possibility that transmission might be put on standby prior to switching from the CAN-FD protocol to the CAN protocol. To address this, the present exemplary embodiment is configured such that the communication method is switched to the low speed CAN protocol prior to transmission being put on standby due to errors occurring in communication based on the CAN-FD protocol, thereby enabling such a lag in communication frames to be suppressed.

When switching the communication method from the CAN-FD protocol to the CAN protocol, the ECU 10A of the present exemplary embodiment transmits a protocol switchover request toward the ECU 10B. Also when switching the communication method from the CAN-FD protocol to the CAN protocol, the ECU 10B of the present exemplary embodiment transmits protocol switchover permission toward the ECU 10A. In cases in which the predetermined duration elapses without receiving the protocol switchover permission from the ECU 10B, the protocol switchover section 112 of the ECU 10A switches the communication method from the CAN-FD protocol to the CAN protocol. Likewise, in cases in which a predetermined duration has elapsed without receiving the protocol switchover request from the ECU 10A, the protocol switchover section 112 of the ECU 10B switches the communication method from the CAN-FD protocol to the CAN protocol.

In this manner, the ECUs 10 of the present exemplary embodiment enable protocol switching on both the transmission side and the reception side to be performed based on the passage of time, even in cases in which there is an issue in communication with the ECU 10 configuring the communication partner during protocol switching. Note that the predetermined duration at which protocol switchover is triggered is preferably set to a duration that does not allow the error counter 108 to reach the count value for transitioning to the passive state.

In the communication system 12 of the present exemplary embodiment, when the communication method is switched from the CAN-FD protocol to the CAN protocol, the modified frame creation section 114 divides the communication data included in the communication frame based on the CAN-FD protocol and allocates the communication data to communication frames based on the CAN protocol in sequence from the shortest permitted lag time. Communication data with a higher priority such as that relating to equipment control is sometimes set with a shorter permitted lag time for communication. Thus, the present exemplary embodiment enables a lag to be suppressed when transmitting high priority communication data, even in a state in which the communication speed has slowed.

Note that in cases in which CAN protocol communication frames including the communication data to be transmitted already exist, these CAN protocol communication frames may be utilized and conferred with updated IDs in sequence such that those with a shorter permitted lag time are conferred with a lower ID number. Alternatively, the pre-existing CAN protocol communication frames may be transmitted as they are without conferring updated IDs.

In cases in which the communication system 12 of the present exemplary embodiment is applied to a vehicle, cases may arise in which the ECU 10A has difficulty communicating due to electromagnetic interference during travel while communicating using the CAN-FD protocol, resulting in successive transmission errors that cause the ECU 10B to be placed in a failsafe state. For example, in cases in which the ECU 10B is unable to receive a vehicle speed signal from the ECU 10A, an issue may arise whereby the vehicle is placed in a failsafe state in which a meter is unable to display the vehicle speed although the vehicle is still able to travel. The present exemplary embodiment enables the likelihood of such a failsafe state occurring to be reduced by securing communication. This enables an across-the-board improvement in the commercial potential of products applied with the communication system 12.

Moreover, in cases in which the communication system 12 of the present exemplary embodiment is applied to a vehicle, communication using the CAN protocol is possible in cases in which errors occur during communication based on the CAN-FD protocol. This enables a communication log to be acquired and analyzed by communication using the CAN protocol in order to perform fault diagnostics. This avoids components being replaced based on guesswork in an auto-repair shop or the like due to being unable to acquire the communication log. Namely, the present exemplary embodiment enables the likelihood of the wrong components being replaced to be reduced.

The processing flows described in the above exemplary embodiment are merely examples, and unnecessary steps may be omitted, new steps added, and processing sequences changed within a range not departing from the spirit thereof.

What is claimed is:

1. A communication device comprising:
a memory; and
a processor coupled to the memory,
the processor being configured to:
transmit a communication frame toward another communication device connected to the communication device through a communication path;
determine whether or not an error has occurred in the transmission of the communication frame; and
switch a communication method for transmitting the communication frame from a first protocol to a second protocol that has a slower communication speed than the first protocol, in a case in which determination is made that an error occurrence rate during transmission using the first protocol is equal to or greater than a predetermined limit.

2. The communication device of claim 1, wherein:
the processor is configured to direct a notification toward the other communication device to request a switch to the second protocol in a case in which the communication method is to be switched from the first protocol to the second protocol; and
the processor is configured to switch the communication method for transmitting the communication frame from the first protocol to the second protocol, in a case in which a predetermined duration has elapsed without receiving a response advising of a switch to the second protocol from the other communication device toward which the notification was directed.

3. The communication device of claim 1, wherein:
the processor is configured to switch the communication method for transmitting the communication frame from the second protocol to the first protocol, in a case in which determination is made that an error occurrence rate during transmission using the second protocol is less than a predetermined limit.

4. The communication device of claim 1, wherein the processor is configured to:
control transmission based on a CAN protocol and a CAN-FD protocol;
perform conversion to divide communication data included in a communication frame based on the CAN-FD protocol serving as the first protocol, and allocate the divided communication data to communication frames based on the CAN protocol serving as the second protocol; and
allocate the divided communication data to the communication frames based on the CAN protocol in sequence from a shortest permitted lag time.

5. The communication device of claim 1, wherein the processor is configured to:
control an error counter to count errors based on a CAN protocol and a CAN-FD protocol so as to increment a number of errors in a case in which an error is determined to have occurred, and to decrement the number of errors in a case in which transmission is determined to have been successful,
wherein, when a count value in the error counter is taken as the error occurrence rate, a count value set as the predetermined limit is a lower value than a count value at which a transmission state is switched from an active state to a passive state.

6. A communication system comprising a plurality of communication devices of claim 1, wherein:
among the plurality of communication devices, the other communication device configuring the communication device on a reception side is configured to receive the communication frame from the communication device on a transmission side; and
a processor of the other communication device is configured to:
determine whether or not an error is present in the communication frame received, and
switch the communication method for receiving the communication frame from the first protocol to the second protocol, in a case in which determination is made that an error occurrence rate during reception using the first protocol is equal to or greater than the predetermined limit.

7. A communication system comprising a plurality of communication devices of claim 2, wherein:
among the plurality of communication devices, the other communication device configuring the communication device on a reception side is configured to receive the communication frame from the communication device on a transmission side; and
a processor of the other communication device is configured to:
determine whether or not an error is present in the communication frame received, and
switch the communication method for receiving the communication frame from the first protocol to the second protocol, in a case in which determination is made that an error occurrence rate during reception using the first protocol is equal to or greater than the predetermined limit, and a predetermined duration has elapsed without receiving the notification from the communication device.

8. A protocol switchover method comprising:
by a processor,
transmitting a communication frame from a communication device toward another communication device connected to the communication device through a communication path;
determining whether or not an error has occurred in the transmission of the communication frame; and
switching a communication method for transmitting the communication frame from a first protocol to a second protocol that has a slower communication speed than the first protocol, in a case in which determination is made that an error occurrence rate during transmission using the first protocol is equal to or greater than a predetermined limit.
